(19) United States
(12) Patent Application Publication
(10) Pub. No.: US 2004/0085278 A1
(43) Pub. Date: May 6, 2004

(54) In-plane switching mode liquid crystal display device having improved aperture ratio

(75) Inventors: Gee-Sung Chae, Icheon (KR); Jae-Kyun Lee, Gyeonggi-do (KR); Ik-Soo Kim, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/674,421

(22) Filed: Oct. 1, 2003

(30) Foreign Application Priority Data
Oct. 31, 2002 (KR) 67253/2002

(51) Int. Cl. G09G 3/36

(52) U.S. Cl. 345/90

(57) ABSTRACT

An in-plane switching mode liquid crystal display device includes a plurality of gate lines and data lines defining a plurality of pixels, a driving device in each of the pixels, a pixel electrode in each of the pixels and a common electrode completely overlapping a data line in width.

The present invention claims the benefit of Korean Patent Application No. 2002-67253 filed in Korea on Oct. 31, 2002, which is hereby incorporated by reference.

### BACKGROUND OF THE INVENTION

1. Field of the Invention

The present invention relates to an in-plane switching mode liquid crystal display device, and more particularly, to an in-plane switching mode liquid crystal display device having an improved aperture ratio.

2. Description of the Related Art

Various portable devices with displays, such as mobile phones, personal digital assistants (PDA) and notebook computers, have been developed. A flat panel display device, which can be used in such portable devices, has been actively studied. Liquid crystal display (LCD), plasma display panel (PDP), field emission display (FED) and vacuum fluorescent display (VFD) devices are all flat panel displays that have all been actively researched. However, the LCD is typically used because of its ease to mass produce, simple driving means and high image quality.

The LCD device has various display modes according to the arrangement of the liquid crystal molecules used in the display. Among these display modes, a twisted nematic (TN) mode is used because of its good black and white display characteristics, fast response time and low driving voltage. In a TN mode LCD device, the liquid crystal molecules are aligned to be in parallel with a substrate and are oriented nearly vertically to the substrate when the voltage is applied. The viewing angle is narrow when the voltage is applied due to the refractive anisotropy of the liquid crystal molecules.

To solve the viewing angle problem of the TN mode LCD device, other various modes of LCD devices having a wide viewing angle characteristic are used. An in-plane switching (IPS) mode LCD device has a wide viewing angle, and is relatively easy to mass produce. The IPS mode LCD device switches the liquid crystal molecules in a plane by forming at least a pair of parallel electrodes arranged in the pixel. The parallel electrodes form a horizontal electric field that is actually parallel with the substrate.

FIG. 1 is a plan view showing a structure of a related art in-plane switching mode LCD device. Generally, the in-plane switching mode LCD device comprises a plurality of pixels.

FIG. 1 only illustrates two adjacent pixels for ease in describing a pixel. Of course, an IPS LCD device can have hundreds or thousands of pixels. In the pixels, a common electrode 17 and a pixel electrode 19 are both arranged substantially in parallel with the data line 5, as shown in FIG. 1. Further, the common electrode 17 is connected to the common line 18.

As shown FIG. 1, a thin film transistor 10 is formed in a pixel defined by gate lines 3 and data lines 5 arranged in longitudinal and transverse directions. The thin film transistor 10 is disposed adjacent to where a gate line 3 and the data line 5 cross each other. The thin film transistor includes a gate electrode 11 connected to the gate line 3, a semiconductor layer 12 on the gate electrode 11, and a source electrode 13 and a drain electrode 14 on the semiconductor layer 12. The source electrode 13 is connected to the data line 5 and the drain electrode 14 is connected to a pixel electrode 19. The thin film transistor 10 is activated by a scan signal to apply an image signal input. More particularly, the thin film transistor 10 is activated by the application of the scan signal to the gate electrode 11 to form a channel layer through which the image signal is applied from the data line 5 via the source electrode 13 and the drain electrode 14.

As described above, the liquid crystal molecules in the IPS mode LCD device are substantially aligned in the parallel direction of the common electrode 17 and the pixel electrode 19. When an image signal is applied to the pixel electrode 19 by the operation of the thin film transistor 10, a horizontal electric field which is parallel with the surface of the liquid crystal display panel 1 is generated between the common electrode 17 and the pixel electrode 19. Since the liquid crystal molecules are rotated in the same plane along with the horizontal electric field, the gray inversion due to the refractive anisotropy of the liquid crystal molecules can be prevented.

FIGS. 2A and 2B are cross-sectional views of the related IPS mode LCD device, where FIG. 2A is a cross-sectional view along the line A-A of FIG. 1 showing the structure of the thin film transistor 10. FIG. 2B is a cross-sectional view along the line B-B of FIG. 1 showing a pixel structure of the IPS mode LCD device. As shown in FIG. 2A, the gate electrode 11 is formed on a first substrate 20 and a gate insulating layer 22 is deposited over the gate electrode 11. A semiconductor layer 12 is formed on the gate insulating layer 22. The source electrode 13 and the drain electrode 14 are formed on the gate insulating layer 22. Also, a passivation layer 24 is formed over the source electrode 13, drain electrode 14 and the gate insulating layer 22.

A black matrix 32 and a color filter layer 34 are formed on a second substrate 30. The black matrix 32 is for blocking the transmission of light into the area where the liquid crystal molecules are not operated. The black matrix is mainly formed over the thin film transistor 10 and between the pixels (that is, the gate line area and the data line area) as shown in FIG. 2A. The color filter layer 34 comprises R (Red), B (Blue) and G (Green) colors for realizing actual colors. The liquid crystal layer 40 is formed between the first substrate 20 and the second substrate 30 such that a liquid crystal display panel is fabricated.

As shown in FIG. 2B, the common electrode 17 is formed on the first substrate 20 and the pixel electrode 19 is formed over the gate insulating layer 22 for generating a horizontal electric field between the common electrode 17 and the pixel electrode 19. The liquid crystal molecules are initially arranged along with the alignment direction of the alignment layer. Actually, the liquid crystal molecules are arranged in the direction having the predetermined angle with the common electrode and the pixel electrode. The liquid crystal molecules are rotated along with the horizontal electric field between the common electrode 17 and the pixel electrode 19 in the pixels to display an image on the screen.

In an IPS mode LCD device, the liquid crystal molecules are rotated along with the horizontal electric field to be aligned. Thus, the gray inversion caused by the refractive anisotropy of the liquid crystal molecule can be prevented. Therefore, the IPS mode LCD device has wider viewing angle characteristic than that of the TN mode LCD device. The TN mode LCD device uses a transparent metal, such as indium tin oxide (ITO), as the common electrode and the pixel electrode. However, the IPS mode LCD device uses an opaque metal as the common electrode and the pixel electrode. Therefore, the IPS mode LCD device has a lower aperture ratio than that of the TN mode LCD device. A lower aperture ratio decreases the resolution and quality of a displayed image.

### SUMMARY OF THE INVENTION

An object of the present invention is to provide an in-plane switching mode liquid crystal display device having an improved aperture ratio.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve the object of the present invention, as embodied and broadly described herein, there is provided an in-plane switching mode liquid crystal display device including a plurality of gate lines and data lines defining a plurality of pixels, a driving device in each of the pixels, a pixel electrode in each of the pixels and a common electrode completely overlapping a data line in width.

In another aspect, there is provided an in-plane switching mode liquid crystal display device including a plurality of gate lines and data lines defining a plurality of pixels, a driving device in each pixel, at least one pixel electrode in each pixel, a first common electrode completely overlapping the data line in width and at least one second common electrode in each pixel.

In yet another aspect, an in-plane switching mode liquid crystal display device includes a plurality of gate lines and data lines defining a plurality of pixels, a first pixel electrode in a first pixel, a first driving device in the first pixel, a second pixel electrode in a second pixel, a second driving device in the second pixel, a passivation layer for insulating the first and second driving devices, and a first common electrode formed between the first and second pixel electrodes and on the passivation layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view showing a related IPS mode LCD device.

FIG. 2A is a cross-sectional view along the line A-A of FIG. 1.

FIG. 2B is a cross-sectional view along the line B-B of FIG. 1.

FIG. 3A is a plan view of an IPS mode LCD device according to an embodiment of the present invention.

FIG. 3B is a cross-sectional view along the line C-C in FIG. 3A.

FIG. 4 is a cross-sectional view showing a structure of an IPS mode LCD device according to another embodiment of the present invention.

FIG. 5 is the plan view showing a structure of an IPS mode LCD device according to yet another embodiment of the present invention.

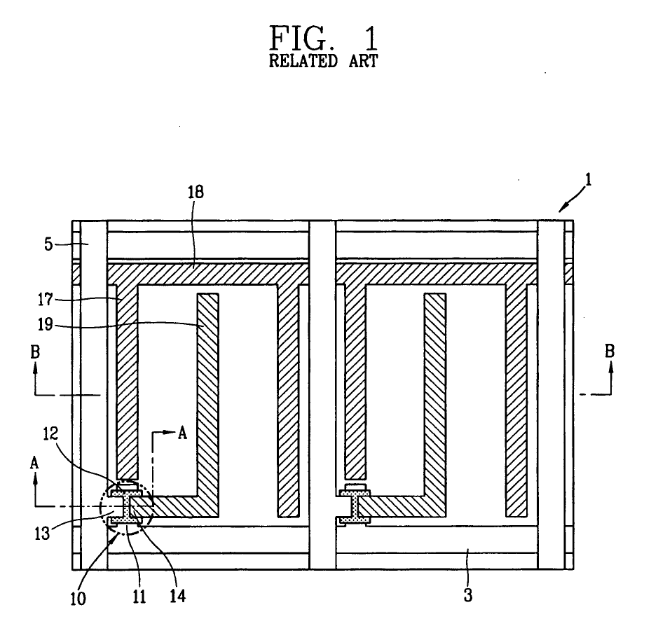

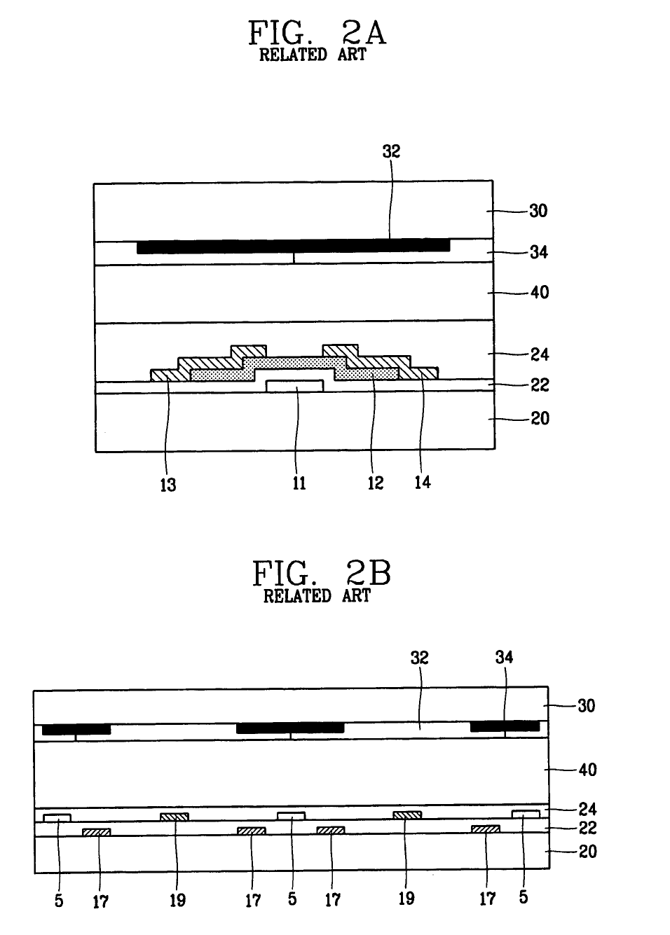

### DETAILED DESCRIPTION OF THE ILLUSTRATED EMBODIMENTS

Reference will now be made in detail to the illustrated embodiments of the present invention, examples of which are illustrated in the accompanying drawings.

Generally, in the related art IPS mode LCD device, the common electrode is disposed adjacent to the data line for the following reasons. When the signal is applied to the pixel electrode, an electric field is generated between the pixel electrode and the data line. This electric field distorts the horizontal electric field which is generated between the common electrode and the pixel electrode to drive liquid crystal molecules in a liquid crystal layer, and as a result a vertical cross talk is generated on the display screen. The electric field between the data line and the pixel electrode may be shielded from the data line by disposing the common electrode along a side of the data line, that is, between the data line and the pixel electrode, so as to prevent distortion of the horizontal electric field applied to the liquid crystal layer.

As described above, since a common electrode is formed along a side of the data line for two adjacent pixels, common electrodes are disposed along both sides of the data line. Generally, the IPS mode LCD device has a lower aperture ratio than that of a TN mode LCD device. More specifically, the aperture ratio of IPS mode LCD device is reduced by the common electrodes disposed along both sides of a data line in each pixel of an array of pixels.

Embodiments of the present invention provide an IPS mode LCD device having an improved aperture ratio. In embodiments of the present invention, the aperture ratio is improved by minimizing the light blockage of an image due to the common electrodes disposed adjacent to the data line. More specifically, the common electrode for two adjacent pixels overlaps the data line to maximize the aperture ratio by eliminating the two common electrodes along both sides of the data line. By overlapping the data line with the common electrode, the effect of common electrodes along the data line is obtained. To prevent the electric field generated between the data line and the pixel electrode from being distorted, the width of the common electrode overlapping with data line should preferably be larger than that of the data line. Hereinafter, the IPS mode LCD device according to embodiments of the present invention will be described in more detail with reference to accompanying Figures.

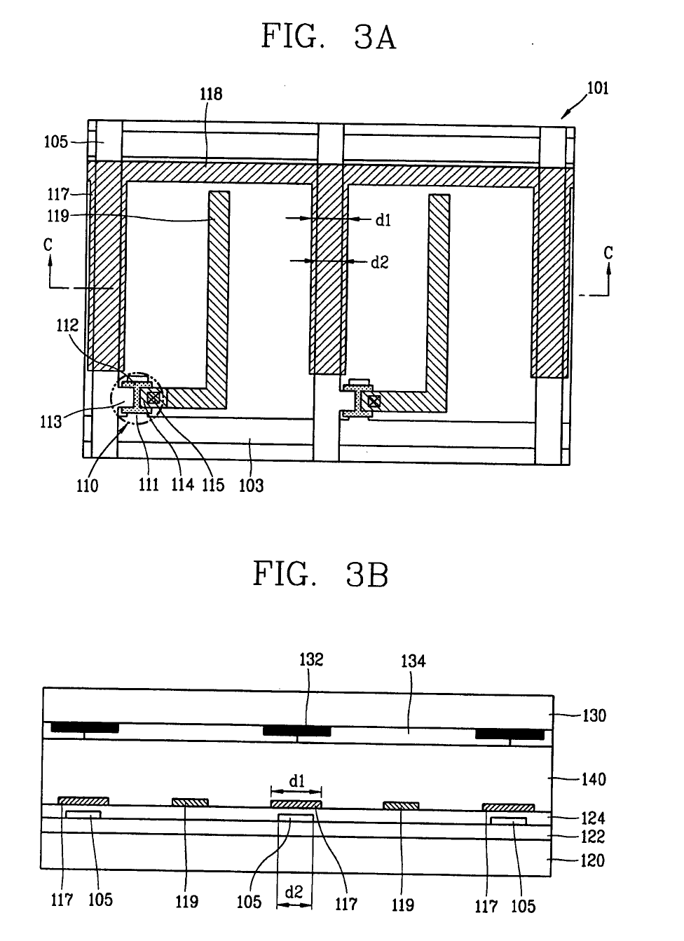

FIG. 3A is a plan view of an IPS mode LCD device according to an embodiment of the present invention. FIG. 3 only illustrates two adjacent pixels for ease in describing a pixel. Of course, an IPS LCD device according to embodiments of the present invention can have hundreds or thousands of pixels. As shown in FIG. 3A, a thin film transistor 110 including a gate electrode 111, a semiconductor layer 112, a source electrode 113 and a drain electrode 114 is formed in the respective pixel defined by a gate line 103 and a data line 105. A pixel electrode 119 is arranged in the pixel to be substantially parallel with the data line 105. Further, a common electrode 117 is arranged overlapping the data line 105. In other words, the common electrode 117 is disposed on the boundary between pixels so that the common electrode 117 is shared by the adjacent two pixels. That is, the common electrode 117 contributes to the generation of the horizontal electric field for two adjacent pixels.

FIG. 3B is a cross-sectional view along the line C-C in FIG. 3A. As shown in FIG. 3B, the data line 105 is formed on a gate insulating layer 122. Further, the common electrode 117 and the pixel electrode 119 are formed on a passivation layer 124. The common electrode 117 is arranged to completely overlap the data line 105 with the passivation layer 124 therebetween. Typically, the gate insulating layer 122 or the passivation layer 124 is formed of an inorganic material, such as SiNx or SiOx. In embodiments of the present invention, since the passivation layer 124 is sandwiched between the data line 105 and the common electrode 117, a coupling capacitance can be generated between the data line 105 and the common electrode 117. This coupling capacitance can cause a distortion in the horizontal electric field between the common electrode 117 and the pixel electrode 119. Thus, the passivation layer in embodiments of the present invention is preferably be formed of an organic material such as benzo-cyclo-butene (BCB) or photoacryl to prevent the generation of a large coupling capacitance.

As shown in FIG. 3A, the common electrode 117 can be formed to have a larger width d1 than the width d2 of the data line 105 (d1>d2) to prevent the vertical cross talk on the screen by blocking the electric field between the data line 105 and the pixel electrode 119. As further shown in FIG. 3A, a contact hole 115 is formed in the passivation layer 124 on upper part of the drain electrode 114 of the thin film transistor 110. The pixel electrode 119 on the passivation layer 124 is connected to the drain electrode 114 of the thin film transistor 110 through the contact hole 115 such that an input signal input can be applied to the pixel electrode 119.

The common electrode 117 is connected to a common line 118. The common line 118 can be formed on the passivation layer 124, as shown in 3B. In the alternative, the common line 118 can be formed on the first substrate 120. In the case that the common line 118 is formed on the first substrate 120, through the contact hole (not shown) formed in the gate insulating layer 122 and in the passivation layer 124, to connect common electrode 117 with the common line 118.

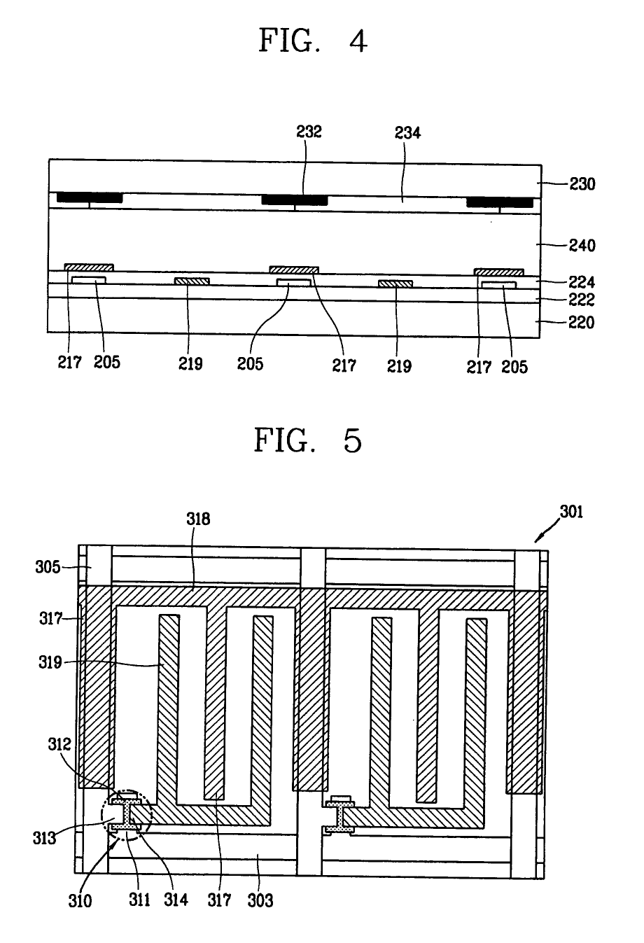

FIG. 4 is a cross-sectional view showing a structure of an IPS mode LCD device according to another embodiment of the present invention. The IPS mode LCD device shown in the FIG. 4 has similar features to those shown in the IPS mode LCD device shown in FIG. 3. Therefore, the descriptions for similar features will be omitted.

As shown in FIG. 4, the data line 205 and the pixel electrode 219 are formed on the gate insulating layer 222 while the common electrode 217 is formed on the passivation layer 224, which is made of an organic material, for example. The common electrode 217 overlaps the data line 205 with the organic passivation layer 224 therebetween. Also, the common electrode 217 is formed to have a larger width than that of the data line 205 so that the electric field between the data line 205 and the pixel electrode 219 is blocked to prevent the distortion of the horizontal electric field applied to the liquid crystal layer.

As shown in FIG. 4, the structural difference of the IPS mode LCD device of this embodiment from the IPS mode LCD device shown in FIG. 3 is the position of the electrode. That is, the data line is formed on the gate insulating layer, and the common electrode and the pixel electrode are formed on the organic passivation layer in the IPS mode LCD device shown in FIG. 3, while the data line 205 and the pixel electrode 219 are formed on the gate insulating layer 222, and the common electrode 217 are formed on the organic passivation layer 224 in the IPS mode LCD device shown in FIG. 4. As described above, although the electrodes shown in FIG. 3 and the electrodes of this embodiment are formed at different positions or on different layers, the effects of preventing the distortion of the horizontal electric field applied to the liquid crystal layer are nearly the same. The positions of the common electrode and the pixel electrode are not limited to particular layers in the IPS mode LCD device according to embodiments of the present invention. In other words, if the common electrode is formed to completely overlap the data line with a width greater than that of the data line, the common electrode and the pixel electrode may be formed on any layer.

The IPS mode LCD devices shown in FIGS. 3A, 3B and 4 are a 2-block IPS mode LCD device. A block is an area displaying an image by transmitting light through a liquid crystal layer. A block can be defined according to the number of common and pixel electrodes. In the 2-block IPS mode LCD device, one pixel electrode and two common electrodes are disposed to form two light transmitting areas in each pixel. However, in the 2-block IPS mode LCD device according to embodiments of the present invention, the common electrode for two adjacent pixels is arranged completely overlapping a data line. Thus, in embodiments of the present invention only the pixel electrode is arranged in each pixel of the 2-block IPS mode LCD device.

The IPS mode LCD device according embodiments of the present invention is not limited to any particular block structure. The number of blocks in the LCD device is variable according to various factors, such as the area of LCD device, the number of pixels and pitch between pixels. Accordingly, an IPS mode LCD device according to embodiments of the present invention can have 4 blocks, 6 blocks or more blocks.

As shown in FIG. 5, four light transmitting areas are defined by the common electrode 317 and the pixel electrode 319 to form pixels of a 4-block IPS mode LCD device. More particularly, the four light transmitting areas are disposed between the three common electrodes 317 and two pixel electrodes 319. Since the two common electrodes are arranged along with the data line 305, however, only one common electrode 317 and two pixel electrodes 319 are arranged in the pixel. Preferably, the common electrode arranged in the pixel is formed to have the same width as that of a pixel electrode in the related art, that is, to have smaller width than that of the common electrode arranged along with the data line 305. As described above, with the common electrode completely overlapping the data line, even in case that the number of blocks is increased, the number of common electrodes actually arranged in the pixel is less than that of the related art by two (2). Therefore, light-blocking caused by opaque common electrodes is minimized. Consequently, the aperture ratio is improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An in-plane switching mode liquid crystal display device, comprising:
a plurality of gate lines and data lines defining a plurality of pixels;
a driving device in each of the pixels;
a pixel electrode in each of the pixels; and
a common electrode completely overlapping a data line in width.

2. The device of claim 1, wherein the driving device is a thin film transistor.

3. The device of claim 2, wherein the thin film transistor comprises:
a gate electrode on a substrate;
an insulating layer over the gate electrode;
a semiconductor layer on the insulating layer;
a source electrode and a drain electrode on the semiconductor layer; and
a passivation layer over the source electrode, drain electrode and semiconductor layer.

4. The device of claim 3, wherein the data lines are formed on the insulating layer.

5. The device of claim 3, wherein the common electrode is formed on the passivation layer.

6. The device of claim 3, wherein the pixel electrode is formed on the insulating layer.

7. The device of claim 3, wherein the pixel electrode is formed on the passivation layer.

8. The device of claim 3, wherein the passivation layer is formed of an organic material.

9. The device of claim 8, wherein the passivation layer is formed of one of BCB (Benzo-Cyclo-Butene) and photoacryl.

10. An in-plane switching mode liquid crystal display device, comprising:
a plurality of gate lines and data lines defining a plurality of pixels;
a driving device in each pixel;
at least one pixel electrode in each pixel;
a first common electrode completely overlapping the data line in width; and
at least one second common electrode in each pixel.

11. The device of claim 10, wherein a width of the first common electrode is larger than that of the second common electrode.

12. An in-plane switching mode liquid crystal display device, comprising:
a plurality of gate lines and data lines defining a plurality of pixels;
a first pixel electrode in a first pixel;
a first driving device in the first pixel;
a second pixel electrode in a second pixel;
a second driving device in the second pixel;
a passivation layer for insulating the first and second driving devices; and
a first common electrode formed between the first and second pixel electrodes, and on the passivation layer.

13. The device of claim 12, wherein the first common electrode completely overlaps a data line.

14. The device of claim 12, wherein the passivation layer is formed of one of BCB (Benzo-Cyclo-Butene) and photoacryl.

15. The device of claim 12, further comprising:
a second common electrode in the first pixel for forming a horizontal electric field with the first pixel electrode; and
a third common electrode in the second pixel for forming a horizontal electric field with the second pixel electrode.

16. The device of claim 12, wherein a width of the first common electrode is larger than that of one of the second common electrode and the third common electrode.
